(19) United States
(12) Patent Application Publication
(10) Pub. No.: US 2025/0102112 A1
(43) Pub. Date: Mar. 27, 2025

(54) HYDROGEN FILLING CONTROL METHOD, HYDROGEN FILLING SYSTEM, AND VEHICLE CONTROLLER

(71) Applicant: SUBARU CORPORATION, Tokyo (JP)

(72) Inventor: Tomohiro ABE, Tokyo (JP)

(21) Appl. No.: 18/882,074

(22) Filed: Sep. 11, 2024

(30) Foreign Application Priority Data
Sep. 21, 2023 (JP) 2023-154144

(51) Int. Cl. F17C 5/00

(52) U.S. Cl. CPC F17C 5/007; F17C 2221/012; F17C 2223/0123; F17C 2250/034; F17C 2250/0434; F17C 2270/0168

(57) ABSTRACT

A hydrogen filling control method includes: acquiring first and second hydrogen tank data; acquiring third hydrogen tank data; and determining a hydrogen tank combination based on the first, second, and third hydrogen tank data. The first hydrogen tank data includes internal pressure of a first hydrogen tank provided in a first vehicle. The second hydrogen tank data includes internal pressure of a second hydrogen tank provided in the first vehicle. The third hydrogen tank data includes internal pressure of a third hydrogen tank provided in a second vehicle. The hydrogen tank combination indicates which hydrogen tanks to be involved in hydrogen filling, out of the first and second hydrogen tanks provided in the first vehicle, and the third hydrogen tank provided in the second vehicle.

### CROSS-REFERENCE TO RELATED APPLICATIONS

The present application claims priority from Japanese Patent Application No. 2023-154144 filed on Sep. 21, 2023, the entire contents of which are hereby incorporated by reference.

### BACKGROUND

The disclosure relates to a hydrogen filling control method, a hydrogen filling system, and a vehicle controller.

Japanese Unexamined Patent Application Publication (JP-A) No. 2004-146113 discloses a technique in which, when a fuel cell vehicle has a hydrogen shortage, emergency hydrogen filling is performed from another fuel cell vehicle by using a differential pressure. JP-A No. 2010-236673 discloses a hydrogen gas filling system. The hydrogen gas filling system is configured to hold a filling profile. The filling profile defines filling pressure when filling a tank with a hydrogen gas, every time when a certain time elapses since a start of filling. The hydrogen gas filling system is configured to control the filling pressure in accordance with the filling profile.

International Patent Application Publication WO 2021/210206 A1 and Japanese Unexamined Patent Application Publication (Translation of PCT Application) (JP-T) No. 2016-526136 disclose techniques in which, when a hydrogen station is in operation, a gas is discharged from a hydrogen tank to fill a vehicle tank with the gas, based on pressure of the gas in multiple hydrogen tanks.

### SUMMARY

An aspect of the disclosure provides a hydrogen filling control method including: acquiring first hydrogen tank data and second hydrogen tank data, in which the first hydrogen tank data includes internal pressure of a first hydrogen tank provided in a first vehicle, the second hydrogen tank data includes internal pressure of a second hydrogen tank provided in the first vehicle, and the internal pressure of the second hydrogen tank is different from the internal pressure of the first hydrogen tank; acquiring third hydrogen tank data including internal pressure of a third hydrogen tank provided in a second vehicle different from the first vehicle; and determining a hydrogen tank combination based on the first hydrogen tank data, the second hydrogen tank data, and the third hydrogen tank data acquired by the acquiring of the first hydrogen tank data and the second hydrogen tank data, and the acquiring of the third hydrogen tank data, in which the hydrogen tank combination indicates which hydrogen tanks to be involved in hydrogen filling, out of the first hydrogen tank and the second hydrogen tank provided in the first vehicle, and the third hydrogen tank provided in the second vehicle.

An aspect of the disclosure provides a hydrogen filling system including: one or more processors; and one or more memories coupled to the one or more processors. The one or more processors are configured to acquire first hydrogen tank data and second hydrogen tank data. The first hydrogen tank data includes internal pressure of a first hydrogen tank provided in a first vehicle. The second hydrogen tank data includes internal pressure of a second hydrogen tank provided in the first vehicle. The internal pressure of the second hydrogen tank is different from the internal pressure of the first hydrogen tank. The one or more processors are configured to acquire third hydrogen tank data including internal pressure of a third hydrogen tank provided in a second vehicle different from the first vehicle. The one or more processors are configured to determine a hydrogen tank combination based on the first hydrogen tank data, the second hydrogen tank data, and the third hydrogen tank data. The hydrogen tank combination indicates which hydrogen tanks to be involved in hydrogen filling, out of the first hydrogen tank and the second hydrogen tank provided in the first vehicle, and the third hydrogen tank provided in the second vehicle.

An aspect of the disclosure provides a vehicle controller including an amount-of-remaining-hydrogen measurer and a hydrogen filling controller. The amount-of-remaining-hydrogen measurer is configured to generate amount-of-remaining-hydrogen-gas data regarding a hydrogen gas stored in a hydrogen tank of a vehicle. The hydrogen filling controller is configured to make a hydrogen filling control of the hydrogen tank of the vehicle. The hydrogen filling controller is configured to make the hydrogen filling control based on tank pair data. The tank pair data includes an amount of filling or filling time when inter-vehicle hydrogen filling is performed. The tank pair data is generated based on the amount-of-remaining-hydrogen-gas data generated by the amount-of-remaining-hydrogen measurer.

An aspect of the disclosure provides a vehicle controller including circuitry. The circuitry is configured to: generate amount-of-remaining-hydrogen-gas data regarding a hydrogen gas stored in a hydrogen tank of a vehicle; and make a hydrogen filling control of the hydrogen tank of the vehicle. The circuitry is configured to make the hydrogen filling control based on tank pair data, the tank pair data including an amount of filling or filling time when inter-vehicle hydrogen filling is performed. The tank pair data is generated based on the amount-of-remaining-hydrogen-gas data generated by the circuitry.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram of an example of an overall configuration of a hydrogen filling system for a vehicle to realize a hydrogen filling control method according to an embodiment of the disclosure.

FIG. 2 is a block diagram of a configuration example of a vehicle controller according to the embodiment.

FIG. 3 is a block diagram of a configuration example of a data processor according to the embodiment.

FIG. 4 is a flowchart of an example of operation of the hydrogen filling system according to the embodiment.

FIG. 5 is a flowchart of an example of the operation of the hydrogen filling system according to the embodiment.

FIG. 6 is a flowchart of an example of the operation of the hydrogen filling system according to the embodiment.

FIG. 7 is a schematic diagram of an example of the hydrogen filling control method according to the embodiment.

### DETAILED DESCRIPTION

To perform inter-vehicle hydrogen filling, it is desirable to appropriately select a supplier vehicle available for hydrogen supply to a vehicle requesting hydrogen filling.

It is desirable to provide a hydrogen filling control method, a hydrogen filling system, and a vehicle controller that make it possible to select a combination of a supplier tank and a fillable tank on the occasion of inter-vehicle hydrogen filling.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description.

### <1. Overall Configuration of Hydrogen Filling System>

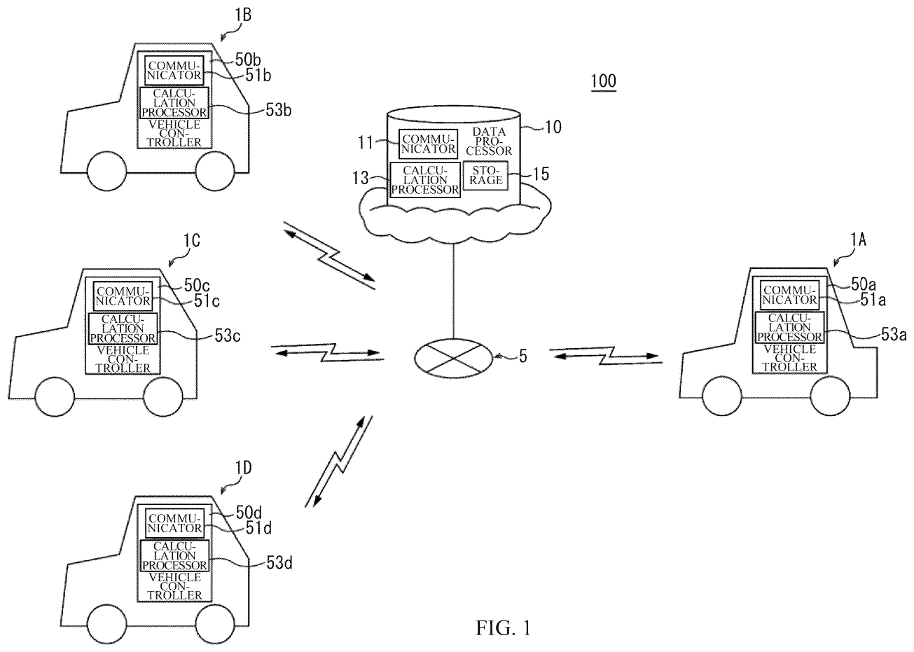

First, with reference to FIG. 1, description is given, in outline, of a hydrogen filling system for a vehicle to realize a hydrogen filling control method according to an embodiment of the disclosure. FIG. 1 is a schematic diagram of an example of an overall configuration of a hydrogen filling system according to the embodiment.

The hydrogen filling system 100 may include vehicle controllers 50a, 50b, 50c, and 50d, and a data processor 10. The vehicle controllers 50a, 50b, 50c, and 50d are respectively provided in vehicles 1A, 1B, 1C, and 1D. The data processor 10 is configured to communicate with the vehicle controllers 50a 50b, 50c, and 50d. In the following, the vehicles 1A, 1B, 1C, and 1D are each simply referred to as a “vehicle 1” when no distinction is necessary. Similarly, the vehicle controllers 50a, 50b, 50c, and 50d are each simply referred to as a “vehicle controller 50” when no distinction is necessary.

The vehicle 1 may include, for example, a known fuel cell vehicle (FCV). The vehicle 1 may include one or more hydrogen tanks inside it. For purposes of easier understanding of the disclosure, description is given with illustration of the four vehicles 1A, 1B, 1C, and 1D, but there are no particular limitations on the number of vehicles to be coupled to the data processor 10.

In the hydrogen filling system 100 according to this embodiment, when receiving a request for hydrogen filling from the vehicle controller 50a of the vehicle 1A, the data processor 10 may search a travel route of the vehicle 1A for a random vehicle available for inter-vehicle hydrogen supply to the vehicle 1A.

Furthermore, the data processor 10 may determine a tank pair for hydrogen supply and hydrogen filling, based on a hydrogen filling mode requested by the vehicle 1A, e.g., a rapid filling mode or a close packed mode. Because the vehicles 1 are devoid of a device that compresses hydrogen, the hydrogen supply and the hydrogen filling are performed by using a difference in internal pressure between hydrogen tanks.

As illustrated in, for example, FIG. 1, the data processor 10 is configured to communicate with the vehicle controller 50 of each vehicle 1 through a wireless communication network 5. The data processor 10 may include a communicator 11, a calculation processor 13, and a storage 15. The data processor 10 may include, for example, a cloud server having a configuration described above.

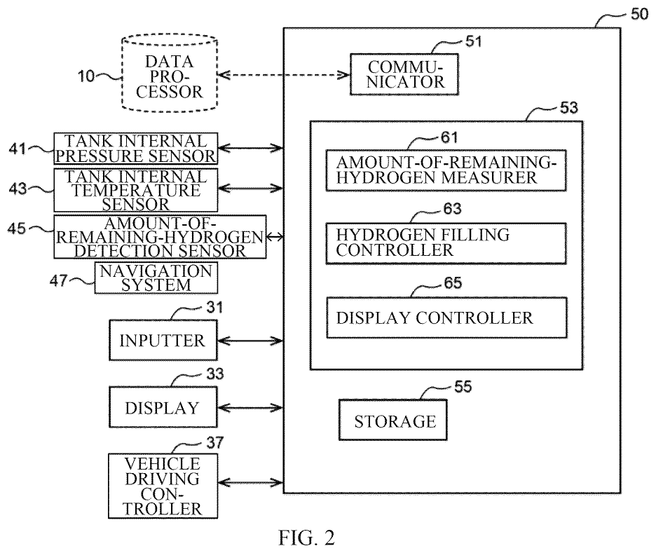

The vehicle controller 50 may be mounted on the vehicle 1. The vehicle controller 50 is configured to make a predetermined control of the vehicle 1 based on a command from the data processor 10. As illustrated in FIG. 2, the vehicle controller 50 may include a communicator 51, a calculation processor 53, and a storage 55. The vehicle controller 50 is configured to communicate with the data processor 10 through the wireless communication network 5 such as mobile communication.

### <2. Configuration Example of Vehicle Controller>

Description is given next of a configuration example of the vehicle controller 50 according to this embodiment. FIG. 2 is a block diagram of the configuration example of the vehicle controller 50 according to this embodiment.

The vehicle controller 50 may include, for example, a calculation processor such as a CPU (Central Processing Unit) or an MPU (Micro Processing Unit), and a storage element such as a RAM (Random Access Memory) or a ROM (Read Only Memory). A part or all of the vehicle controller 50 may include an updatable one such as firmware, or may include a program module or the like to be executed by a command from a CPU or the like.

The communicator 51 may include an interface to transmit and receive signals between the vehicle controller 50 and the data processor 10. In this embodiment, the communicator 51 is configured to communicate with the data processor 10 through the wireless communication network 5.

The calculation processor 53 may include at least one CPU or MPU as described above. The calculation processor 53 is configured to make various kinds of calculation processing by executing a program held in the storage 55.

The storage 55 may include a storage medium such as a HDD (Hard Disk Drive), a CD (Compact Disc), a DVD (Digital Versatile Disc), an SSD (Solid State Drive), a USB (Universal Serial Bus) flash memory, and a storage device in addition to or in place of a storage element such as a RAM or a ROM.

The vehicle controller 50 may be coupled to various sensors such as a tank internal pressure sensor 41, a tank internal temperature sensor 43, and an amount-of-remaining-hydrogen detection sensor 45, and a navigation system 47 directly or through a communication line such as a CAN (Controller Area Network) or a LIN (Local Internet). The tank internal pressure sensor 41 is a known sensor installed in a known hydrogen tank provided in a vehicle and used for detection of pressure of a hydrogen gas contained in the hydrogen tank. The tank internal temperature sensor 43 is a known sensor installed in a known hydrogen tank provided in a vehicle and used for detection of an internal temperature of the hydrogen tank. The amount-of-remaining-hydrogen detection sensor 45 is a known sensor used for detection of an amount of remaining hydrogen in the hydrogen tank. Data acquired by the various sensors may be transmitted to the vehicle controller 50. The various sensors may operate while receiving electric power supply from, for example, a power supply of the vehicle 1.

The navigation system 47 may guide the vehicle 1 to a set destination based on position data regarding the vehicle 1 transmitted from, for example, GPS (Global Positioning System) satellites. In one example, the navigation system 47 may include unillustrated GPS antennae and receive satellite signals from the GPS satellites. The satellite signals may include data regarding the current position of the vehicle 1. The navigation system 47 may set the destination based on data regarding the destination inputted by an occupant such as a driver through an inputter 31. Alternatively, the navigation system 47 may set the destination of the vehicle 1 based on the data regarding the destination transmitted from, for example, another controller configured to control automated driving.

The navigation system 47 may generate data regarding proposed travel routes from the current position of the vehicle 1 to the destination. In this embodiment, the navigation system 47 may transmit, to the vehicle controller 50, the data regarding the current position of the vehicle 1 and the data regarding the proposed travel routes to the destination. The navigation system 47 may set, as the travel route, a travel route selected by the occupant such as the driver from the proposed travel routes. The navigation system 47 may reflect the travel route in map data, and display the travel route on a display 33 installed in the vehicle.

The navigation system 47 is not limited to a system using the satellite signals from the GPS satellites, but may be a system configured to receive satellite signals including the position data regarding the vehicle 1 from other satellite systems. When the vehicle 1 is a vehicle configured to make an automated driving control, the navigation system 47 may transmit the travel route to the set destination to the controller configured to control the automated driving.

The vehicle controller 50 may be coupled to the inputter 31, the display 33, and a vehicle driving controller 37 directly or through the communication line such as the CAN or the LIN. The inputter 31 may receive an operation input by the occupant with respect to the vehicle controller 50. The inputter 31 may be, for example, a touchscreen display or a dial operation device.

The display 33 may include, for example, a display panel provided on a dashboard, or a HUD (Head Up Display) configured to project an image on a windshield. The display 33 may provide information to allow the occupant to visually recognize the information. The display 33 may be a meter display in an instrument panel, a display of the navigation system 47, or a multi-function display configured to provide various kinds of information. However, the display 33 is not limited to the display panel and the HUD mentioned above. The display 33 may be integrated with the inputter 31.

The vehicle driving controller 37 is configured to make a driving control of the vehicle 1. The vehicle driving controller 37 may include one or more controllers configured to control driving of, for example, an unillustrated driving motor, an unillustrated steering system, and an unillustrated brake system. The vehicle driving controller 37 may make the driving control of the vehicle 1 based on, for example, a driving operation by the occupant.

The calculation processor 53 may include a processor such as a CPU, as mentioned above. The calculation processor 53 may include an amount-of-remaining-hydrogen measurer 61, a hydrogen filling controller 63, and a display controller 65. Each of them may be a function to be realized by a processor executing a program.

### (Amount-of-Remaining-Hydrogen Measurer)

The amount-of-remaining-hydrogen measurer 61 may generate amount-of-remaining-hydrogen-gas data regarding the hydrogen gas stored in the hydrogen tank mounted on the vehicle 1. Such amount-of-remaining-hydrogen-gas data may include hydrogen gas pressure data regarding the hydrogen gas in the hydrogen tank detected by the tank internal pressure sensor 41. The amount-of-remaining-hydrogen-gas data may further include temperature data regarding the hydrogen gas detected by the tank internal temperature sensor 43. The amount-of-remaining-hydrogen-gas data may further include a substance amount of the hydrogen gas stored in the hydrogen tank calculated based on detection values of the tank internal pressure sensor 41 and the tank internal temperature sensor 43. The amount-of-remaining-hydrogen-gas data may further include a substance amount of the hydrogen gas detected by the amount-of-remaining-hydrogen detection sensor 45. The “substance amount” means the number of moles derived from the state equation of a gas. The amount-of-remaining-hydrogen-gas data may further include data regarding the number of the hydrogen tanks mounted on the vehicle. In this embodiment, the amount-of-remaining-hydrogen measurer 61 may generate the amount-of-remaining-hydrogen-gas data mentioned above, based on an input by the occupant through the inputter 31.

### (Hydrogen Filling Controller)

The hydrogen filling controller 63 may control the hydrogen filling with respect to the hydrogen tank mounted on the vehicle 1. In one example, the hydrogen filling controller 63 may control opening and closing of an unillustrated valve provided in a hydrogen tank filling port, based on the detection values of, for example, the tank internal pressure sensor 41 and the tank internal temperature sensor 43.

### (Display Controller)

The display controller 65 may control display to be provided on the display 33 in the vehicle 1. In one example, the display controller 65 may display a determination by the data processor 10 described later, and also control display of the contents of the input to the inputter 31.

### <3. Configuration Example of Data Processor>

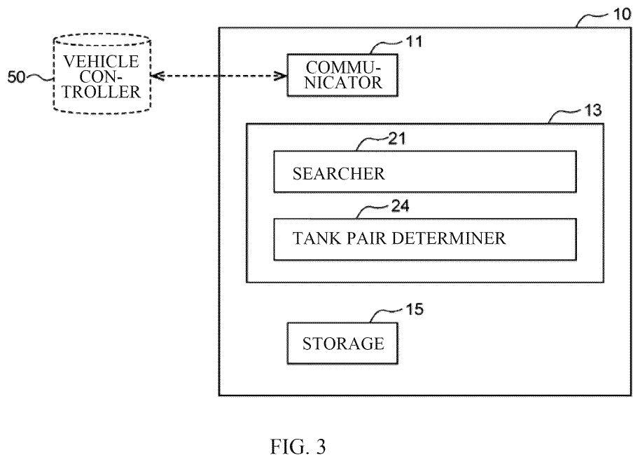

Description now moves on to a configuration example of the data processor 10 according to this embodiment. FIG. 3 is a block diagram of the configuration example of the data processor 10 according to this embodiment.

The data processor 10 may perform predetermined processing, e.g., processing described later, based on data transmitted from the vehicle controller 50 of the vehicle 1. The data processor 10 may transmit a result of the processing to the sender vehicle or other vehicles.

The data processor 10 may include a communicator 11, a calculation processor 13, and a storage 15. The communicator 11 may include an interface to establish communication with the wireless communication network 5. The data processor 10 is configured to communicate with the vehicle controllers 50 of the vehicles 1 through the communicator 11.

The storage 15 may include a storage medium such as a HDD (Hard Disk Drive), a CD (Compact Disc), a DVD (Digital Versatile Disc), an SSD (Solid State Drive), a USB (Universal Serial Bus) flash memory, and a storage device. The storage 15 may hold, for example, the amount-of-remaining-hydrogen-gas data transmitted from the vehicle controller 50 of the vehicle 1. The storage 15 may hold travel position data transmitted from the vehicle controller 50 of the vehicle 1 while the vehicle 1 is traveling. The storage 15 may update the travel position data at predetermined time intervals.

The calculation processor 13 may include a processor such as a CPU. A part or all of the calculation processor 13 may include an updatable one such as firmware, or may include a program module or the like to be executed by a command from a CPU or the like.

The calculation processor 13 may include a searcher 21 and a tank pair determiner 24. Each of them may be a function to be realized by a processor executing a program.

### (Searcher)

The searcher 21 may search the travel route of the vehicle 1A for fuel cell vehicles different from the vehicle 1A, e.g., the vehicles 1B, 1C, and 1D, to generate search data. The search data may include, at least, unique numbers (ID) with which the extracted vehicles 1B, 1C, and 1D are identifiable, and the position data regarding each vehicle. The search data may further include the amount-of-remaining-hydrogen-gas data for each vehicle. Furthermore, the searcher 21 may generate the search data by searching for a hydrogen station located on the travel route of the vehicle 1A.

### (Tank Pair Determiner)

The tank pair determiner 24 may determine a hydrogen tank combination. The hydrogen tank combination indicates which hydrogen tanks to be involved in the hydrogen filling on the occasion of the inter-vehicle hydrogen filling. The tank pair determiner 24 may calculate a result value when the hydrogen filling is performed with respect to the tank pair, and generate tank pair data. In one example, the tank pair data may include data regarding an amount of filling when the hydrogen filling is performed with respect to the tank pair. Moreover, the tank pair data may further include data regarding filling time it takes to perform the hydrogen filling with respect to the tank pair. Furthermore, the tank pair data may further include data regarding the hydrogen tank internal temperature after the filling, as a result of the hydrogen filling with respect to the tank pair. These pieces of the tank pair data may be generated based on the detection values of, for example, the tank internal pressure sensor 41 and the tank internal temperature sensor 43. The tank pair determiner 24 may transmit the generated tank pair data to the vehicle controller 50.

### <4. Flowchart of Operation Example of Hydrogen Filling System>

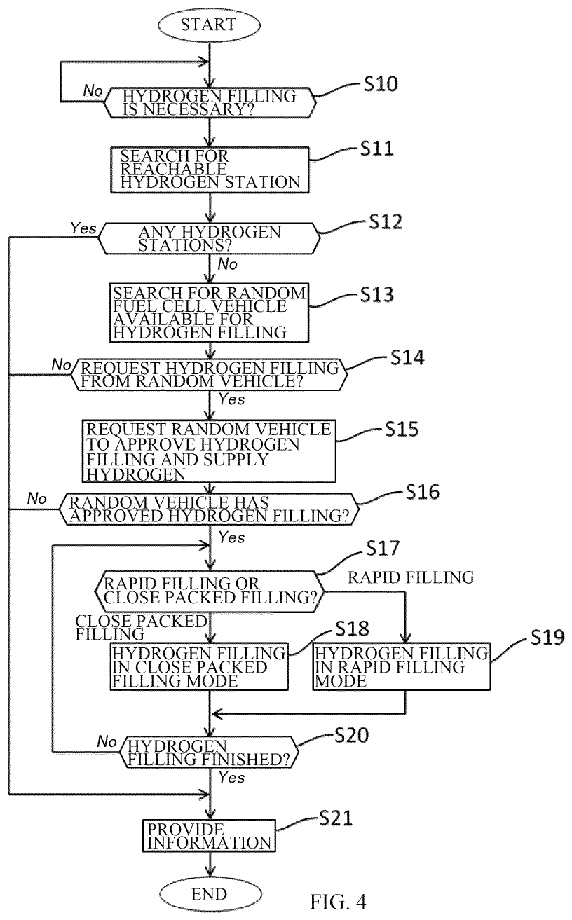

Next, with reference to the flowchart in FIG. 4, description is given of an example of operation of the vehicle controller 50 and the data processor 10 constituting the hydrogen filling system 100 according to this embodiment. The hydrogen filling control method by the hydrogen filling system 100 of this embodiment is a method to determine the tank pair for the filling in accordance with the realizable amount of filling or the realizable filling time on the occasion of hydrogen transfer between fuel cell vehicles.

As illustrated in FIG. 4, the data processor 10 may determine whether hydrogen filling is necessary for the vehicle 1A (step S10). In one example, the data processor 10 may determine that the hydrogen filling is necessary, based on the amount-of-remaining-hydrogen-gas data from the vehicle controller 50a of the vehicle 1A. For example, the data processor 10 may receive the amount-of-remaining-hydrogen-gas data generated by the amount-of-remaining-hydrogen measurer 61 of the vehicle 1A. Thus, for example, when the amount-of-remaining-hydrogen-gas data indicates that the amount of the remaining gas affords a cruising distance of 50 kilometers or less, the data processor 10 may determine that the hydrogen filling is necessary for the vehicle 1A.

When it is determined that the hydrogen filling is necessary (Yes in step S10), the data processor 10 may search for a hydrogen station reachable for the vehicle 1A (step S11). Based on the data regarding the current position of the vehicle 1A, the data processor 10 may transmit, to the navigation system 47 of the vehicle 1A, the position data regarding the hydrogen station on the travel route of the vehicle 1A or within a radius of a few kilometers around the vehicle 1A.

When it is determined that the hydrogen filling is unnecessary for the vehicle 1A (No in step S10), the data processor 10 may repeat the processing from step S10 again.

When a hydrogen station reachable for the vehicle 1A is retrieved (Yes in step S12), the data processor 10 may transmit data regarding the retrieved hydrogen station to the vehicle 1A to provide the information (step S21), and may end the processing (END).

When no hydrogen stations reachable for the vehicle 1A are retrieved (No in step S12), the data processor 10 may search for random fuel cell vehicles available for the hydrogen supply to the vehicle 1A (step S13). For example, the data processor 10 may search the travel route of the vehicle 1A for fuel cell vehicles different from the vehicle 1A, e.g., the vehicles 1B, 1C, and 1D, to generate the search data.

Thereafter, the data processor 10 may determine, based on the acquired search data, whether to make the request for the filling from each of the vehicles 1B, 1C, and 1D (step S14). In one example, the data processor 10 may provide the occupant of the vehicle 1A with display of the vehicles 1B, 1C, and 1D on the display 33. The data processor 10 may determine whether to make the request for the filling based on, for example, the input to the inputter 31 by the occupant of the vehicle 1A.

Although not illustrated, between steps S13 and S14, the data processor 10 may carry out a process of determining which vehicle is to supply hydrogen to the vehicle 1A. In one example, the data processor 10 may determine which vehicle is to supply hydrogen to the vehicle 1A, based on, for example, the position data regarding the vehicles 1B, 1C, and 1D. The data processor 10 may determine which vehicle is to supply hydrogen, based on, for example, data regarding the amount of the hydrogen filling on the occasion of the hydrogen filling with respect to a specific tank pair or the filling time it takes to perform the hydrogen filling with respect to the specific tank pair. The data regarding the amount of the hydrogen filling or the filling time is included in the tank pair data generated by the tank pair determiner 24. Moreover, the data processor 10 may determine which vehicle is to supply hydrogen to the vehicle 1A, based on, for example, the input to the inputter 31 by the occupant of the vehicle 1A. Carrying out the process described above between steps S13 and S14 makes it possible to calculate the amount of hydrogen to be obtained from each vehicle and the necessary filling time in advance before making the request for the filling from the random vehicles, e.g., the vehicles 1B, 1C, and 1D, perform ranking, and thereafter, make the request for the filling. It is to be noted that the process described above may be performed between steps S16 and S17 described later.

When it is determined not to make the request for the filling (No in step S14), the data processor 10 may end the processing (END).

When it is determined to make the request for the filling (Yes in step S14), the data processor 10 may transmit the request for the hydrogen supply to the vehicles 1B, 1C, and 1D (step S15). When receiving approvals of the hydrogen supply from the vehicles 1B, 1C, and 1D (Yes in step S16), the data processor 10 may determine the filling mode (step S17).

In step S17, the data processor 10 may determine whether to perform the hydrogen filling in the close packed filling mode (step S18) or whether to perform the hydrogen filling in the rapid filling mode (step S19). This determination as to the filling mode may be made based on, for example, a command based on the input to the inputter 31 by the occupant of the vehicle 1A.

Thereafter, the data processor 10 may advance the hydrogen filling processing for the vehicle 1A (steps S18 and S19). After an end of the hydrogen filling processing (Yes in step S20), the data processor 10 may provide a filling result to the vehicle controller 50a of the vehicle 1A (step S21), and end the series of processes. Details of the hydrogen filling processing (steps S18 and S19) are described later.

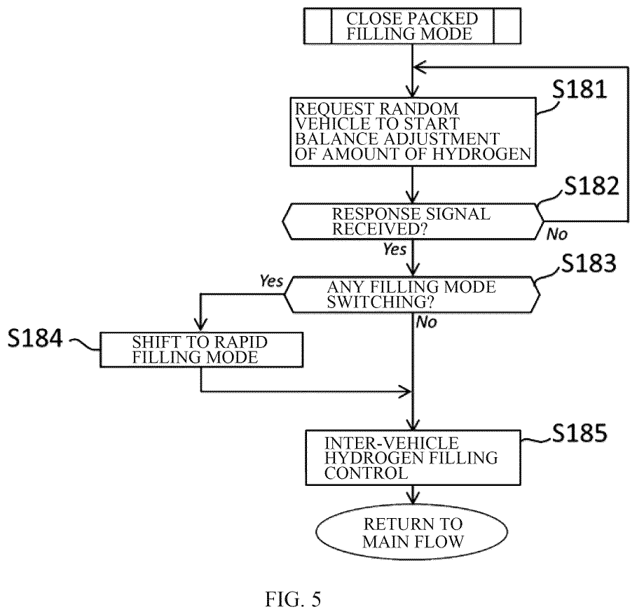

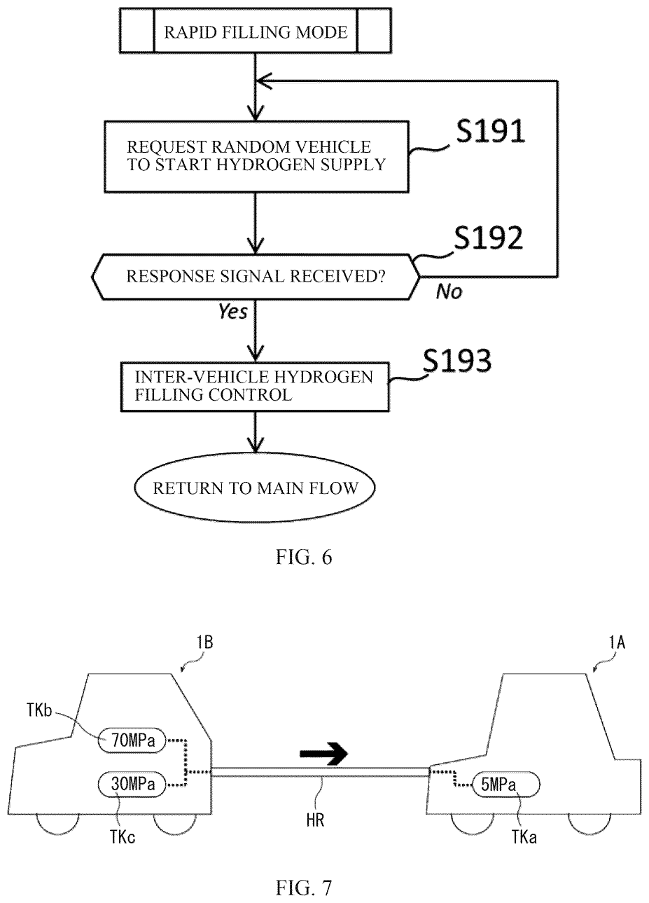

In the hydrogen filling control method to be realized by the hydrogen filling system 100 of this embodiment, it is possible to carry out the inter-vehicle hydrogen filling processing in accordance with the filling mode. In one example, it is possible to carry out the processing differently in accordance with the close packed filling mode illustrated in FIG. 5 or the rapid filling mode illustrated in FIG. 6. The close packed filling mode is processing that makes it possible to relatively increase the amount of filling with respect to the tank in the vehicle 1A. The rapid filling mode is processing that makes it possible to relatively shorten the filling time it takes to fill the hydrogen tank of the vehicle 1A.

### <<Close Packed Filling Mode>>

With reference to FIGS. 5 and 7, the close packed filling mode of this embodiment is described. The data processor 10 may request the vehicle controller 50b of the supplier vehicle 1B to start to adjust amounts of hydrogen in hydrogen tanks TKb and TKc (step S181). In one example, the data processor 10 may calculate a difference in internal pressure between the hydrogen tanks TKb and TKc. When there is no difference in the internal pressure, the data processor 10 may carry out a process of allowing the vehicle controller 50b of the supplier vehicle 1B to generate the difference in the internal pressure. For example, the data processor 10 may carry out a process of giving priority to using hydrogen stored in either the hydrogen tank TKb or the hydrogen tank TKc.

Thereafter, the data processor 10 may receive a response signal from the vehicle controller 50b (step S182). After receiving the response signal (Yes in step S182), the data processor 10 may determine whether to make filling mode switching (step S183). When determining to make the filling mode switching (Yes in step S183), the data processor 10 may carry out a process of switching to the rapid filling mode (step S184) described later. Criteria for the determination as to whether to make the filling mode switching may include, for example, when no difference in the internal pressure between the hydrogen tanks TKb and TKc is generated.

When determining not to make the filling mode switching (No in step S183), the data processor 10 may make an inter-vehicle filling control (step S185). In one example, the data processor 10 may send a command to couple a known hydrogen supply pipe HR to each vehicle.

Thereafter, after confirming that the hydrogen supply pipe HR has been coupled to each vehicle, the data processor 10 may allow the vehicle controller 50a of the supplied vehicle 1A to carry out a process of opening a filling valve of the hydrogen tank TKa having the internal pressure of, for example, 5 MPa. Moreover, the data processor 10 may allow the vehicle controller 50b of the supplier vehicle 1B to carry out a process of opening a supply valve of whichever hydrogen tank has the smaller difference in the internal pressure with respect to the hydrogen tank TKa, out of the hydrogen tanks mounted on the supplier vehicle 1B. For example, the data processor 10 may carry out a process of opening a supply valve of the hydrogen tank TKc having the internal pressure of, for example, 30 MPa illustrated in FIG. 7.

After detecting that the internal pressure of the hydrogen tank TKc and the internal pressure of the hydrogen tank TKa has reached equilibrium, the data processor 10 may determine that the hydrogen filling processing between the two tanks has been ended, and perform a process of closing both the filling valve and the supply valve described above. Thereafter, although not illustrated, the data processor 10 may perform the processing of the inter-vehicle filling control between the hydrogen tanks TKb and TKa.

In the close packed filling mode, it is possible to perform, first, the filling process from whichever supplier tank, out of the tanks mounted on the supplier vehicle, has the smaller difference in the internal pressure with respect to the fillable tank, and thereafter, switch the coupling to whichever supplier tank has the greater difference in the internal pressure to perform the filling process. As described, the data processor 10 may determine whichever hydrogen tank combination provides a relatively greater amount of the hydrogen filling, or determine whichever order of the hydrogen filling provides a relatively greater amount of the hydrogen filling. Hence, it is possible to make the inter-vehicle filling control that prioritizes the amount of the hydrogen filling.

It is to be noted that the data processor 10 may perform an opening and closing control of the filling valve and the supply valve as mentioned above, to prevent the internal temperature of the hydrogen fillable tank, i.e., the hydrogen tank TKa, from becoming equal to or higher than a predetermined value, based on the internal temperature data regarding the hydrogen tank acquired during the hydrogen filling.

### <<Rapid Filling Mode>>

Next, with reference to FIGS. 6 and 7, the rapid filling mode of this embodiment is described. The data processor 10 may send a command to couple the known hydrogen supply pipe HR to each vehicle. Thereafter, after confirming that the known hydrogen supply pipe HR has been coupled to each vehicle, the data processor 10 may transmit a request to start the hydrogen supply to the supplied vehicle 1A, to the vehicle controller 50b of the supplier vehicle 1B (step S191).

After the data processor 10 receives the response signal from the vehicle controller 50b (Yes in step S192), the data processor 10 may transmit an inter-vehicle filling control signal to the vehicle controller 50a of the supplied vehicle 1A and the vehicle controller 50b of the supplier vehicle 1B (step S193).

In one example, the data processor 10 may allow the vehicle controller 50a of the supplied vehicle 1A to perform the process of opening the filling valve of the hydrogen tank TKa having the internal pressure of, for example, 5 MPa. Moreover, the data processor 10 may allow the vehicle controller 50b of the supplier vehicle 1B to perform the process of opening the supply valve of whichever hydrogen tank, out of the hydrogen tanks mounted on the supplier vehicle 1B, has the greater difference in the internal pressure with respect to the hydrogen tank TKa. In FIG. 7, the data processor 10 may carry out a process of opening a supply valve of the hydrogen tank TKb having the internal pressure of, for example, 70 MPa. Thus, performing the filling process from whichever supplier tank having the greater difference in the internal pressure with respect to the fillable tank makes it possible to make the inter-vehicle filling control that prioritizes the filling time.

When the amount of hydrogen received by the supplied vehicle 1A becomes greater than the amount of hydrogen requested by the supplied vehicle 1A, the data processor 10 may determine that the hydrogen filling processing has been finished, and perform the process of closing both the filling valve and the supply valve mentioned above. Alternatively, the data processor 10 may determine that the hydrogen filling processing has been finished after detecting that the internal pressure of the hydrogen tank TKb and the internal pressure of the hydrogen tank TKa has reached equilibrium, and perform the process of closing both the filling valve and the supply valve mentioned above.

In this filling mode, the data processor 10 may perform the above-described opening and closing control of the filling valve and the supply valve, to prevent the internal temperature of the hydrogen fillable tank, i.e., the hydrogen tank TKa, from becoming greater than the predetermined value based on the internal temperature data regarding the hydrogen tank acquired during the hydrogen filling.

As described, in the hydrogen filling control method to be performed by the hydrogen filling system 100 for the vehicle in this embodiment, it is possible to match the hydrogen supplier vehicle and the hydrogen fillable vehicle in accordance with, for example, the amount of filling and the necessary filling time on the occasion of hydrogen exchange between the fuel cell vehicles.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the forgoing embodiment, the close packed filling mode and the rapid filling mode are described separately. However, one of these processes may be repeated, or both processes may be performed in order. For example, when multiple hydrogen tanks are mounted on the supplied vehicle 1A, repeating the above-described processes makes it possible to more appropriately select the combination of the hydrogen supplier tank and the hydrogen fillable tank.

Moreover, in the forgoing embodiment, inter-vehicle data transmission and reception is performed through the data processor 10, but this is non-limiting. Data transmission and reception may be performed by using known methods such as inter-vehicle communication.

According to the hydrogen filling control method, the hydrogen filling system, and the vehicle controller of the disclosure, it is possible to appropriately select a combination of a hydrogen supplier tank and a hydrogen fillable tank on the occasion of inter-vehicle hydrogen filling.

The disclosure may include the following technical features. For example, in the hydrogen filling control method of the disclosure, the determining of the hydrogen tank combination may include acquiring an amount of filling or filling time with respect to the hydrogen filling between the first hydrogen tank and the third hydrogen tank and with respect to the hydrogen filling between the second hydrogen tank and the third hydrogen tank.

In the hydrogen filling control method of the disclosure, the determining of the hydrogen tank combination may include determining whichever hydrogen tank combination provides a relatively greater amount of the hydrogen filling, or determining whichever order of the hydrogen filling provides a relatively greater amount of the hydrogen filling.

In the hydrogen filling control method of the disclosure, the determining of the hydrogen tank combination may further include acquiring a hydrogen tank internal temperature with respect to the hydrogen filling between the first hydrogen tank and the third hydrogen tank and with respect to the hydrogen filling between the second hydrogen tank and the third hydrogen tank.

In the hydrogen filling system of the disclosure, the one or more processors may carry out processing including generating a difference in the internal pressure between the first tank and the second tank by giving priority to using hydrogen stored in the first hydrogen tank or using hydrogen stored in the second hydrogen tank.

In the hydrogen filling system of the disclosure, the one or more processors may carry out processing including acquiring an amount of filling or filling time with respect to the hydrogen filling between the first hydrogen tank and the third hydrogen tank, and with respect to the hydrogen filling between the second hydrogen tank and the third hydrogen tank.

In the hydrogen filling system of the disclosure, the one or more processors may carry out processing including determining whichever hydrogen tank combination provides a relatively greater amount of the hydrogen filling, or determining whichever order of the hydrogen filling provides a relatively greater amount of the hydrogen filling.

In the hydrogen filling system of the disclosure, the one or more processors may carry out processing including acquiring a hydrogen tank internal temperature with respect to the hydrogen filling between the first hydrogen tank and the third hydrogen tank, and with respect to the hydrogen filling between the second hydrogen tank and the third hydrogen tank.

The vehicle controller 50 of the vehicle 1 and the data processor 10 illustrated in FIGS. 1 to 3 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the vehicle controller 50 of the vehicle 1 and the data processor 10. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the vehicle controller 50 of the vehicle 1 and the data processor 10 illustrated in FIGS. 1 to 3.

1. A hydrogen filling control method comprising:
acquiring first hydrogen tank data and second hydrogen tank data, the first hydrogen tank data including internal pressure of a first hydrogen tank provided in a first vehicle, the second hydrogen tank data including internal pressure of a second hydrogen tank provided in the first vehicle, and the internal pressure of the second hydrogen tank being different from the internal pressure of the first hydrogen tank;
acquiring third hydrogen tank data including internal pressure of a third hydrogen tank provided in a second vehicle different from the first vehicle; and
determining a hydrogen tank combination based on the first hydrogen tank data, the second hydrogen tank data, and the third hydrogen tank data acquired by the acquiring of the first hydrogen tank data and the second hydrogen tank data, and the acquiring of the third hydrogen tank data, the hydrogen tank combination indicating which hydrogen tanks to be involved in hydrogen filling, out of the first hydrogen tank and the second hydrogen tank provided in the first vehicle, and the third hydrogen tank provided in the second vehicle.

2. The hydrogen filling control method according to claim 1, wherein
the first vehicle is configured to generate a difference in the internal pressure between the first hydrogen tank and the second hydrogen tank, by giving priority to using hydrogen stored in the first hydrogen tank or using hydrogen stored in the second hydrogen tank.

3. The hydrogen filling control method according to claim 1, wherein
the acquiring of the first hydrogen tank data and the second hydrogen tank data, and the acquiring of the third hydrogen tank data are performed by inter-vehicle communication between the first vehicle and the second vehicle.

4. A hydrogen filling system comprising:
one or more processors; and
one or more memories coupled to the one or more processors,
wherein the one or more processors are configured to
acquire first hydrogen tank data and second hydrogen tank data, the first hydrogen tank data including internal pressure of a first hydrogen tank provided in a first vehicle, the second hydrogen tank data including internal pressure of a second hydrogen tank provided in the first vehicle, and the internal pressure of the second hydrogen tank being different from the internal pressure of the first hydrogen tank;
acquire third hydrogen tank data including internal pressure of a third hydrogen tank provided in a second vehicle different from the first vehicle; and
determine a hydrogen tank combination based on the first hydrogen tank data, the second hydrogen tank data, and the third hydrogen tank data, the hydrogen tank combination indicating which hydrogen tanks to be involved in hydrogen filling, out of the first hydrogen tank and the second hydrogen tank provided in the first vehicle, and the third hydrogen tank provided in the second vehicle.

5. A vehicle controller comprising:
an amount-of-remaining-hydrogen measurer configured to generate amount-of-remaining-hydrogen-gas data regarding a hydrogen gas stored in a hydrogen tank of a vehicle; and
a hydrogen filling controller configured to make a hydrogen filling control of the hydrogen tank of the vehicle, wherein
the hydrogen filling controller is configured to make the hydrogen filling control based on tank pair data, the tank pair data including an amount of filling or filling time when inter-vehicle hydrogen filling is performed, and
the tank pair data is generated based on the amount-of-remaining-hydrogen-gas data generated by the amount-of-remaining-hydrogen measurer.

6. A vehicle controller comprising circuitry configured to:
generate amount-of-remaining-hydrogen-gas data regarding a hydrogen gas stored in a hydrogen tank of a vehicle; and
make a hydrogen filling control of the hydrogen tank of the vehicle, wherein
the circuitry is configured to make the hydrogen filling control based on tank pair data, the tank pair data including an amount of filling or filling time when inter-vehicle hydrogen filling is performed, and
the tank pair data is generated based on the amount-of-remaining-hydrogen-gas data generated by the circuitry.
